(19) United States
(12) Patent Application Publication
(10) Pub. No.: US 2015/0279227 A1
(43) Pub. Date: Oct. 1, 2015

(54) Psychometric Classification

(71) Applicant: MorphoTrust USA, LLC, Billerica, MA (US)

(72) Inventor: Richard Austin Huber, Weehawken, NJ (US)

(73) Assignee: MORPHOTRUST USA, LLC, Billerica, MA (US)

(21) Appl. No.: 14/675,875

(22) Filed: Apr. 1, 2015

Related U.S. Application Data
(60) Provisional application No. 61/973,802, filed on Apr. 1, 2014.

(51) Int. Cl. G09B 7/06

(52) U.S. Cl. CPC G09B 7/06

(57) ABSTRACT

Methods, systems, and apparatus, including computer programs encoded on a computer storage medium, for monitoring content presented by a computing device to a user. Obtaining information density templates based on the presented content, and obtaining input response data related to inputs received by the computing device from the user. Determining scores for one or more psychometric traits based on the input response data and the information density templates, and storing the scores for the one or more psychometric traits in a psychometric profile of the user.

### CROSS REFERENCE TO RELATED APPLICATIONS

This application claims the benefit of the filing date of U.S. Provisional Application No. 61/973,802, which was filed on Apr. 1, 2014, the contents of which are incorporated by reference in their entirety as part of this application.

### BACKGROUND

Existing user identity verification technologies use passwords, personal identification numbers, or biometric classifiers to authenticate or identify users. Furthermore, traditional ranges of biometrics are directly measurable with some form of sensor. Additionally, traditional ranges of biometrics are largely immutable, that is, one cannot change a biometric trait such as iris sclera topology consciously or based on situational awareness.

### SUMMARY

This specification relates to generating psychometric profiles of a user based on interactions between the user and a computing device, and, in some examples, verifying a user's identity based on the user's interactions with a computing device and a previously generated psychometric profile of the user.

In general, innovative aspects of the subject matter described in this specification can be embodied in methods that include actions of monitoring content presented by a computing device to a user. Obtaining information density templates based on the presented content, and obtaining input response data related to inputs received by the computing device from the user. Determining scores for one or more psychometric traits based on the input response data and the information density templates, and storing the scores for the one or more psychometric traits in a psychometric profile of the user. Other implementations of this aspect include corresponding systems, apparatus, and computer programs, configured to perform the actions of the methods, encoded on computer storage devices.

These and other implementations can each optionally include one or more of the following features. Obtaining the input response data can include measuring a length of responses for inputs received by the computing device from the user. Obtaining the input response data can include measuring a length of time between inputs received by the computing device from the user. Obtaining the information density templates based on the presented content can include converting the content presented to the user into information density templates at regular intervals, where obtaining the input response data includes measuring input response times for inputs received by the computing device from the user during the regular intervals.

Obtaining the input response data can include converting the user inputs into input templates at event based intervals, and measuring input response times for keyboard inputs, mouse inputs, trackball inputs, and touch screen inputs. Monitoring content presented by a computing device to a user can include monitoring any of visiospatial information, window dimensions, paint time, application association, audio information, event and interruption information, dynamic content measurement per unit time, or information density of each of those aspects. Determining scores for one or more psychometric traits based on the input response data and the information density templates can include generating scores for the one or more psychometric traits using a machine learning model. The one or more psychometric traits can be cognitive efficiency traits.

Other implementations described in this specification can be embodied in methods that include actions of monitoring a user's interactions with content provided to the user by a computing device, where the content permits the user to perform a plurality of different types of interactions. Obtaining action count data including a number of times that the user performs each of the plurality of different types of interactions based on monitoring the user's interactions with the provided content. Determining scores for one or more psychometric traits based on the plurality of different types of interactions permitted by the content and the action count data, and storing the scores for the one or more psychometric traits in a psychometric profile of the user. Other implementations of this aspect include corresponding systems, apparatus, and computer programs, configured to perform the actions of the methods, encoded on computer storage devices.

These and other implementations can each optionally include one or more of the following features. The actions can include obtaining action profile data including data identifying multiple interactions available to a user to perform an operation with the content, where determining scores for one or more psychometric traits includes determining scores for one or more psychometric traits based on the plurality of different types of interactions permitted by the content, the action count data, and the action profile data. The actions can include correlating the action count data and the action profile data, where determining scores for one or more psychometric traits includes determining scores for one or more psychometric traits based on the correlated action count data and action profile data.

Monitoring content presented by a computing device to a user can include monitoring a number and type of content provided to a user. Determining scores for one or more psychometric traits based on the plurality of different types of interactions permitted by the content, the action count data can include generating scores for the one or more psychometric traits using a machine learning model. The one or more psychometric traits can be cognitive choice traits.

Other implementations described in this specification can be embodied in methods that include actions of monitoring content presented by a computing device to a user. Obtaining information density templates based on the presented content, obtaining input response data related inputs received by the computing device from the user, and obtaining action profile data including data identifying a plurality of interactions available to a user to perform an operation with the content. Determining action count data including a number of times that the user performs each of the plurality of different types of interactions based on monitoring the user's interactions with the provided content. Determining scores for a first set of one or more psychometric traits based on the input response data and the information density templates, and determining scores for a second set of one or more psychometric traits based on the plurality of different types of interactions permitted by the content and the action count data. And, storing the scores for the first set of one or more psychometric traits and the second set of one or more psychometric traits in a psychometric profile of the user.

Implementations can be combined with traditional identification features and security credentials such as, for example, login credentials and biometrics.

Particular implementations of the subject matter described in this specification can be implemented so as to realize one or more of the following advantages. Implementations may provide increased system security. Implementations may enable continuous or near continuous evaluation of a user identity while the user interacts with a computing device. Implementations may enable user identity verification or identification with minimal interruption to a user.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 depicts an example system in accordance with implementations of the present disclosure.

FIG. 2 depicts an example process for generating a psychometric profile in accordance with implementations of the present disclosure.

FIG. 3 depicts an example process for performing identity verification using a psychometric profile in accordance with implementations of the present disclosure.

FIG. 4 depicts an example process for generating a cognitive efficiency profile of a user in accordance with implementations of the present disclosure.

FIG. 5 depicts an example process for generating a cognitive choice profile of a user in accordance with implementations of the present disclosure.

Like reference symbols in the various drawings indicate like elements.

### DETAILED DESCRIPTION

There exists a domain of unique human activity that can be separated from static and kinetic measurements of musculoskeletal aspects. This domain includes automatic, behavioral, volitional, and other related areas of neurological controls over those overt measurable musculoskeletal aspects. Techniques for the deliberate measurement of those neurological controls from computer event inputs is discussed herein. That is, techniques are described for generating psychometric profiles of a person based on interactions between the person and a computing device. Techniques are also described for using a psychometric profile to verify a person's purported identity or to identify a user of a computing device based on stored profiles.

Generally, psychometrics are measurable psychological traits of an individual (e.g., measurable traits related to an individual's knowledge, attitudes, cognition, or personality). Cognitive strategies are a subset of psychometrics related to an individual's cognitive ability (e.g., an individual's ability to absorb, understand, and act on information).

Generally, a psychometric profile is a statistical or machine learned mapping of multiple psychological traits of an individual. A psychometric profile may be divided into multiple classifier profiles. A classifier profile, generally, may be composed of multiple psychometric traits (e.g., cognitive strategies or measurable psychological traits) that are sufficiently related such that they may be used to classify a unique psychological aspect of a person's identity. Two psychometric classifiers described here are cognitive efficiency and cognitive choice.

Cognitive efficiency generally represents differences in timing that a person takes to absorb, understand, and act on information based on the context in which the information is presented.

Cognitive choice generally represents an individual's decision patterns based on the context in which information is presented and an array of available actions.

In general, a psychometric profile for a person may be developed from a series of user interactions with a computing device. During the computer/user interactions, data related to one or more of the user's psychometric traits (e.g., psychometric traits indicative of the user's cognitive efficiency and/or cognitive choice) may be captured either by the computing device with which the user is interacting or by a second computing device. As will be described in more detail below, the captured data will, generally, include data indicating the content provided by the computing device to the user (e.g., quantity of content, density of content, type of content, and/or number and type of potential different inputs (decisions) the user may provide to interact with content through the computing device) and data related to the user's interactions with (inputs to) the computing device (e.g., the timing of the start, duration, and information density of each of the user's interactions with (inputs to) the computing device; the number of inputs (decisions) and a count each different type of input (decision) provided (made) by the user). A psychometric profile of the user may then be generated by applying machine learning techniques to the captured data. The user's psychometric profile will become more comprehensive over the course of multiple computer/user interaction sessions.

Once a psychometric profile of a user is developed to a sufficient level of confidence, the psychometric profile may be used to verify the user's identity during future interactions and/or to potentially identify an unknown user's identity by comparison to known psychometric profiles. For example, a user's identity may be verified by generating psychometric trait scores based on data captured during a later session and comparing the scores to the user's psychometric profile. If the data captured during the later session indicates a psychometric trait that deviates from the user's psychometric profile by a predetermined threshold amount, it may indicate that the current person interacting with the computing device is not the user identified by the psychometric profile. If the data captured during the later session indicates a psychometric trait that differs within a band threshold, it may indicate that the current person interacting with the computing device is the same user identified by the profile, indicating an increase in sophistication of interaction with the system, or learning.

In other words, for example, a fictional user, Isaac, may have access to a confidential computer system at his company. For added security, his employer may decide to employ a psychometric identity verification application to ensure that anytime someone is logged into the confidential computer system under Isaac's login credentials the user is in fact Isaac.

Initially, the psychometric identity verification application will require a certain period of time to develop a psychometric profile of Isaac. The psychometric identity verification application will monitor Isaac's interaction with the confidential computer system over several computing sessions as described above. For instance, the psychometric identity verification application will develop Isaac's psychometric profile by monitoring and capturing data related to the content provided to Isaac by the confidential computer system and Isaac's interactions with the computer system based on the presented content.

Once Isaac's psychometric profile has been developed to a sufficient level of confidence, the psychometric identity verification application may begin comparing data captured during Isaac's subsequent computing sessions with his profile. If the data collected during a subsequent computing session indicates psychometric traits in conformance with Isaac's profile (e.g., scored traits based on the collected data are equivalent to those in Isaac's profile within a predetermined threshold value) then the psychometric identity verification application will authenticate the user as Isaac. If, however, the data collected during a subsequent computing session indicates psychometric traits not in conformance with Isaac's profile (e.g., scored traits based on the collected data deviate from those in Isaac's profile outside a predetermined threshold value) then the psychometric identity verification application will not authenticate the user as Isaac, and may, for example, lock the computer system.

Furthermore, although, Isaac's psychometric profile has been developed to a level sufficient for identify verification purposes, the psychometric identity verification application also may continue to use subsequent data related to Isaac's continued interaction with the confidential computing system to further refine and develop his psychometric profile.

A psychometric identity verification application may have advantages over other traditional types of security features (e.g., login credentials, access cards, and biometrics, such as, finger print ID and iris and retina scans, etc.) in that the psychometric identity verification application may allow a computing system or device to continually evaluate the identity of a user, while other methods restrict access initially but once access is granted user's may be swapped. Further, since it is focused on cognitive effects solely, purely isolated from morphological effects such as keystroke, mouse, or gesture dynamics, it can potentially be fused with those morphological and motor skill methods for a more accurate profile. For example, if Isaac wished to log into his confidential computer system account and later allow an unauthorized user to perform work on the system through his account, the psychometric identity verification application may be capable of detecting the change in users. The unauthorized user may exhibit (through interactions with the computing system) different psychometric traits from Isaac. The psychometric identity verification application may then detect this difference because the psychometric traits indicated by the unauthorized user's interaction with the computing system deviate from Isaac's psychometric profile, and may lock the computing system.

In some implementations, a psychometric profile, once developed, may be used to classify the user according to aspects of their profile. Such classification may enable content providers to tailor content based on the specific traits of the user. For example, a psychometric profile focused on a user's cognitive or learning traits may be used to classify a group of user's according to their learning styles or skills. A computer based education curriculum may then be tailored to the user's learning style based on the user's psychometric profile. Similarly, for example, an internet shopping website may employ a psychometric profile application to build a psychometric profile of a user based on their interaction with the internet shopping website and through a user account. The internet shopping website may be able to provide the user with advertisements that are more applicable to the user based on a classification of the user's psychometric profile.

For clarity, techniques for developing and using psychometric profiles are described in reference to a user's interaction with a standard personal computer (e.g., a laptop or a desktop computer), however, a psychometric profile of a user may be developed and/or used to identify/verify a user on any type of computing device (e.g., a personal computer, mobile phone, smartphone, tablet computer, computer kiosk, and via a remote desktop application) and using nearly any type of computer input (e.g., keyboard, mouse, touch screen, voice commands, and gesture input). Furthermore, because a psychometric profile captures the psychological traits of an individual, such as cognitive strategy, it is independent of the type of computer/user interface used to build the profile. Thus, a psychometric profile of a user may be developed using one type of computer/user interface (e.g., a personal computer) and used to verify the user's identity on another type of computer/user interface (e.g., a smartphone).

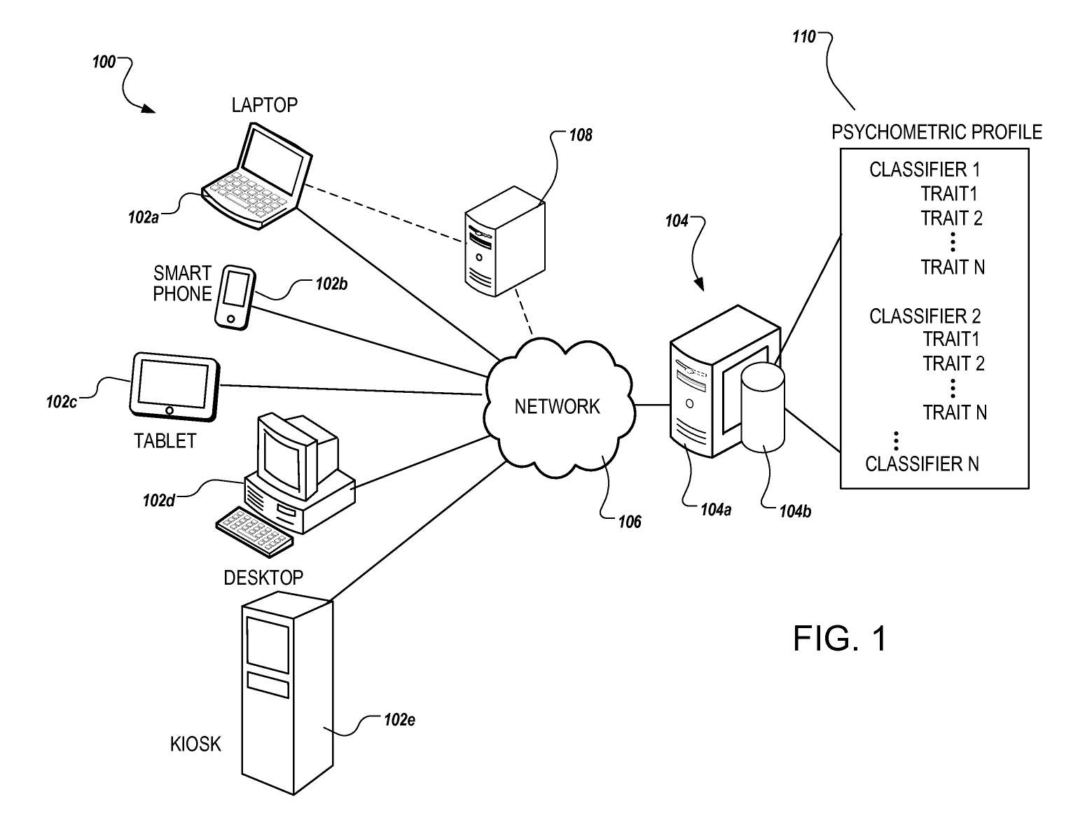

FIG. 1 depicts an example system 100 in accordance with implementations of the present disclosure. For example, system 100 can be used to develop a psychometric profile 110 of a user and perform psychometric user authentication or identification of one or more users. System 100 includes one or more user computing devices 102 (e.g., devices 102a-102e), computing system 104, and network 106. The user computing device 102 can be any type of computing device that permits user interactions, for example, a personal computer 102a, 102d (e.g., a laptop or desktop computer), mobile device 102 b, 102c (e.g., a mobile phone smartphone, tablet computer) or computer kiosk 102e. A user computing device 102 can have internal or external storage components for storing data and programs such as an operating system and one or more application programs. A user computing device 102 also can include a central processing unit (CPU) for executing instructions stored in storage and/or received from one or more other electronic devices, for example over network 106. A user computing device 102 also includes include one or more communication devices for sending and receiving data. One example of such communications devices is a modem. Other examples include antennas, transceivers, communications cards, and other network adapters capable of transmitting and receiving data over a network (e.g., network 106) through a wired or wireless data pathway.

Furthermore, user computing device 102 includes input devices to permit user interaction with the user computing device 102. The input devices may include a keyboard, a mouse, a touch screen, a microphone to receive voice commands, and/or one or more accelerometer(s), camera(s), or sensors to receive gesture commands.

Computing system 104 can be one or more computing devices (e.g., servers) configured to provide content (e.g., hosting websites or network based applications) to user computing device 102. Computing system 104 may have internal or external storage components storing data and programs such as an operating system and one or more application programs. For example, the computing system 104 can each include a computing device 104a and computer-readable memory provided as a persistent storage device 104b, and can represent various forms of server systems including, but not limited to a web server, an application server, a proxy server, a network server, or a server farm. The one or more application programs may be implemented as instructions that are stored in the storage components and that, when executed, cause the one or more computing devices to provide the content to user computing device 102. Furthermore, the computing system 104 may include one or more processors for executing instructions stored in storage and/or received from one or more other electronic devices, for example over network 106. In addition, computing system 104 can include network interfaces and communication devices for sending and receiving data.

Network 106 may provide direct or indirect communication links between data user computing device 102 and computing system 104. Examples of network 106 include the Internet, the World Wide Web, wide area networks (WANs), local area networks (LANs) including wireless LANs (WLANs), analog or digital wired and wireless telephone networks, wireless data networks (e.g., 3G and 4G networks), cable, satellite, and/or any other delivery mechanisms for carrying data.

In implementations of the present disclosure, the user computing device 102 can include a psychometric identification application (PIA). In some implementations, the PIA can operate as a stand-alone application on user computing device 102. The PIA can perform operations, such as, developing user psychometric profiles 110, user authentication (e.g., identify verification), and user identification on user computing device 102. In some implementations, the PIA can be a server based application, for example, an application maintained on computing system 104 and accessed by user computing devices 102 through one or more networks 106.

For example, user computing device 102 may be a laptop computer owned by a business, such as a physician's office. The laptop may contain patient health records and other sensitive information. The physician may employ the PIA to restrict access to the laptop only to health care staff members (e.g., other physicians and nurses). Once the PIA develops a psychometric profile 110 for authorized user's the PIA can be used to verify each user's identity as they interact with the laptop.

In some implementations, the computing system 104 can include a PIA (e.g., a server based PIA). The PIA can perform operations, such as, developing user psychometric profile 110, user authentication, and user identification remotely through a network 106 based on a user's interactions with content delivered to user computing device 102 by computing system 104. In some implementations, the computing system 104 can store and update user psychometric profiles 110 generated by user computing devices 102. For example, PIA's operating on one or more user computing devices 102 can generate user psychometric profile 110 and store the profile 110 or a copy of the profile 110 at computing system 104. In addition, the computing devices 102 can generate and send updates to existing user psychometric profiles 110. In some implementations, psychometric profiles 110 stored at computing system 104 can be used to authenticate or identify a particular user across multiple different user computing devices.

For example, computing system 104 can be a server hosting an online banking application. The bank managers may wish to provide their clients with additional security by incorporating a PIA into their online banking software. The PIA may develop user psychometric profile based on the user's interactions with the online banking application through their user account. Then the PIA may use the psychometric profile to verify that a user who is logged into the online banking application is in fact the owner of the associated account, otherwise the PIA may cause the online banking application to lock the user's account.

In some implementations, system 100 may include computing device 108. Computing device 108 may be one or more computing devices (e.g., servers or routers) configured to provide computing device 102 with access to network 106 (e.g., a LAN server or a gateway router). Computing device 108 can also include a PIA. In such an implementation, the PIA may monitor data packets sent between computing device 102 and one or more computing devices 104. The number, size, rate, and type of data packets sent from computing devices 104 to computing device 102 may provide an indication of the content (e.g., information density) presented to the user of computing device 102. Similarly the timing, size, rate, and type of data packets sent from computing device 102 to computing devices 104 can provide an indication of the input response times for inputs received by computing device 102 from a user. The PIA can use such data related to the data packets transferred between computing device 102 and computing devices 104 to generate a psychometric profile of the user of computing device 102.

In some implementations, a psychometric profile 110 includes one or more classifier profiles. Each classifier profile can be composed of multiple psychometric traits (e.g., cognitive strategies) that are sufficiently related such that they can be used to classify a unique psychological aspect of a given person's identity. For example, two psychometric classifiers that can be included in a psychometric profile 110 are cognitive efficiency and cognitive choice. In some implementations, psychometric traits related to human/machine interactions can be measured based on analyzing a user's interactions with a computing device in relation to content (e.g., visual, audible, or tactile content) presented by the computing device during or before the interactions.

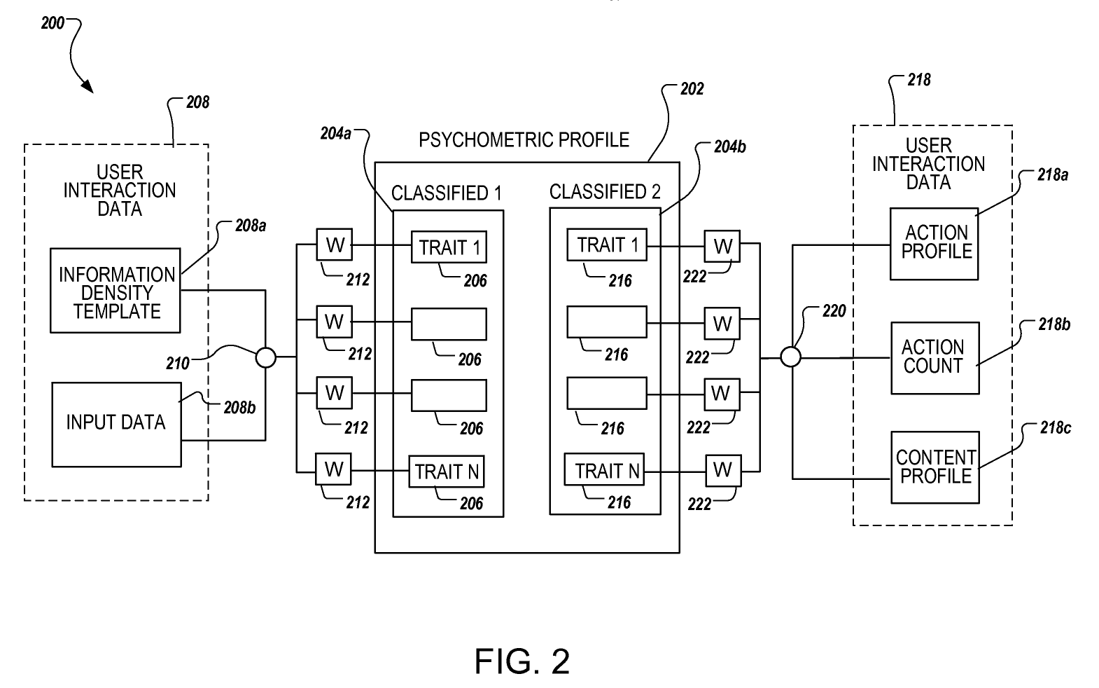

In some implementations, psychometric classifiers can differ from biometric classifiers in a number of ways. For example, where the traditional ranges of biometrics are directly measurable with some form of sensor, psychometrics are typically only indirectly measurable via observed behavior, challenge responses, and statistical relationships. Additionally, the traditional ranges of biometrics are largely immutable, that is, one cannot change a biometric trait such as iris sclera topology consciously or based on situational awareness. Example psychometric traits are described below in reference to FIG. 2 as qualities which can be used in some implementations of a PIA to develop a psychometric profile for a user.

TABLE 1
Characteristics of Psychometric Strength

| Feature | Description | Range |
|---|---|---|
| Measurability | The ability to directly measure | Indirectly, |
| | the characteristic | Directly*** |
| Mutability | Can the measurement of the | Consciously, |
| | characteristic change | Unconsciously, |
| | | Situationally, |
| | | Experientially, |
| | | Immutable |
| Composability | Can a single physical behavioral | Additive (with |
| | measurement be composed from the | Orthogonality), |
| | characteristic to generate a | Neutral, |
| | stronger differentiating signal | Subtractive |

Some example differences between biometrics and psychometrics with respect to these categories are represented in
Table 2 below.

TABLE 2
Relationship of enhanced features to biometrics and psychometrics

| Feature | Biometrics | Psychometrics |
|---|---|---|
| Measurability | Directly | Directly***, Indirectly |
| Mutability | Immutable* | Mutable, discrete ranges |
| Composability | Additive | Additive, Neutral, Subtractive** |
| | (Orthogonal, Fusion) | |

*Excluding cases of physical alteration through medical procedures or injury
**Imply more than one state is possible in the set of all psychometrics
***“Directly” in this context should be considered as “Least Indirectly.”

With respect to the characteristics listed in Table 2, psychometric traits can be evaluated with respect to a maximum and minimum range of ideal psychometric performance. In some examples, a weak psychometric trait would be only indirectly measurable, consciously mutable, and not be composable into a stronger signal with other psychometrics. In some examples, a strong psychometric trait would be directly measurable, immutable or only experientially mutable, and would be additively composable with other characteristics into a stronger signal.

Differentiating Cognitive Effects from the other types of causation in Motor Skill, Morphological, and Schematic effects, we focus on aspects of Choice and Efficiency vectors of Cognitive Strategy. Cognitive strategies (e.g., psychometric traits) related to Choice and Efficiency that are directly (e.g., “least indirectly”) measurable in the domain of human to computer interaction, and relate to timing, visiospatial information, and multipath interaction options presented to the user. Multipath interaction options refers to, for example, the ability to select different paths to achieve the same action within a single human computer interaction (e.g., selecting a menu option with mouse input, gesture input, keyed input, voice command, or eye gaze selection.)

Table 3 provides a list of example psychometric traits (e.g., cognitive strategies) related to choice and efficiency.

TABLE 3
Cognitive Strategies related to Choice and Efficiency

| Cognitive Strategy | Description |
|---|---|
| Field Dependence - | Context as it relates to visual perception |
| Independence | |
| Impulsivity - Reflectivity | Deliberation as it relates to comprehension, |
| | decision |
| Adaptability - Innovation | Adaption or innovation to comprehension, |
| | decision |
| Holist - Serialist | Iterative process or whole context decision |
| Range of scanning | Extensively scanning or limited scanning |
| | before decision |
| Constricted - Flexible | Constrict the perceptual environment or |
| | permit intrusion |

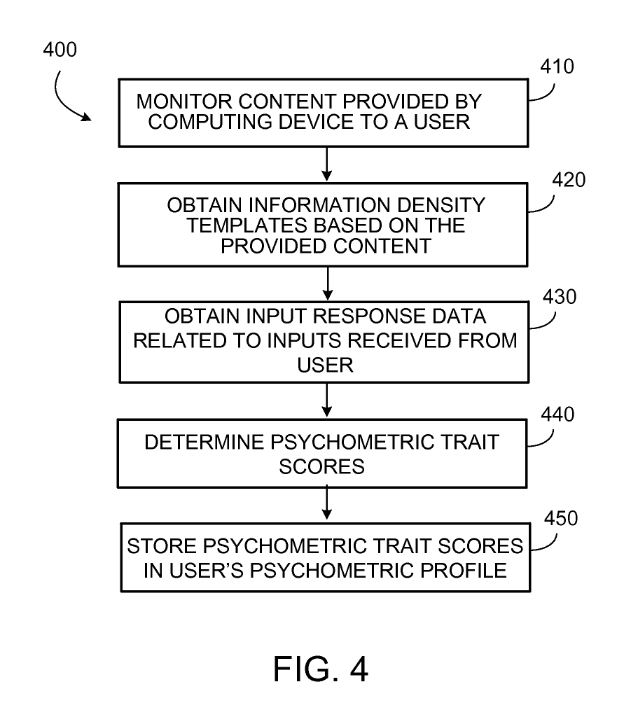

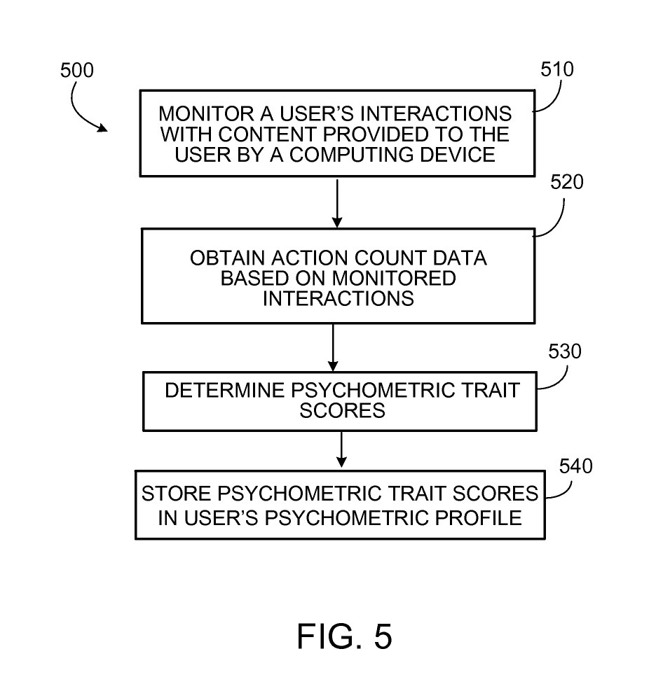

FIG. 2 depicts an example process 200 for generating a psychometric profile 202 in accordance with implementations of the present disclosure. The example psychometric profile 202 includes two classifier profiles, for example, a cognitive efficiency profile 204a and a cognitive choice profile 204b. In addition, each of the classifier profiles 204a, 204b include a plurality of psychometric traits 206, 216. As discussed in more detail below in reference to FIGS. 4 and 5, a PIA can monitor user/computer interactions to generate a cognitive efficiency profile 204a and a cognitive choice profile 204b. For example, a user's interactions with a computing device can be monitored to obtain user interaction data (208, 218). Interaction data can be, for example, measurable data related to interactions between a user and a computing device.

In some examples, interactions can be predicated upon input signals which do not overlap in any way with the traditional range of static biometrics, motor skills, morphological effects, or overlapping domains where some level of cognition and sophistication are being measured, (e.g. forensic authorship or command line lexicon.) Further, the interactions data monitored can be directly measurable from the standard set of peripheral input and output devices available in modern computing devices such as, for example, mouse, keyboard, touchscreen, microphone with either voice or visual information presented to the user.

In some examples, menu and control options exist across a continuum of novice to expert, keyed to mouse input, and in many cases multiple options exist in both a visual and nonvisual context. Choice in application sequencing, command sequencing, parallelism, visiospatial information density, and interruption exist as additional user/computer interactions that can be used monitored and evaluated. In some examples, interactions measured by a PIA can include, for example, visiospatial and auditory information density, timing of interaction, duration of interaction, information density of interaction, parallelism of input and output, and interaction type and method.

Various types of interaction data (208, 218) can be correlated and analyzed to determine correspondence between the measured interactions and one or more psychometric traits. Psychometric trait scores 206, 216 can be generated or refined over time based on interaction data (208, 218) related to a series of user/computer interactions. In some implementations, the PIA can use machine learning techniques (e.g., Simple Bayes, Neural Network, and/or SVM with RBF kernel) to correlate and analyze interaction data, and to determine correspondence be between the measured interaction features and one or more psychometric traits and generate the psychometric trait scores. In some implementations, a measure of correspondence between interaction data and a psychometric trait can be used as a weighting 212, 222 for generating or refining an associated psychometric trait score 206, 216.

For example, referring to generation of a cognitive efficiency profile 204a, a PIA can generate a cognitive efficiency profile 204a for a user based on user/computer interaction data 208 including, for example, information density templates 208a and input response data 208b. In some examples, an information density template 208a can be a representation of visual, audible, or tactile content provided to a user by a computing device. For example, the content may include the number of application windows open, window dimensions, paint time, application association, auditory input, and other estimates of information density. In some examples, information density is a measure of the amount of information presented to a user per unit time and the context in which the information is presented. An example of low information density content is a screen displaying a plain background with a simple image and 1-2 sentences separate from the image. By contrast, an example of high information density content is a screen with multiple windows open for multiple applications, some windows having animated advertisements, and receiving active input from a user (e.g., typing). This information is reduced to an information density template from the perspective of information presented to the user, including static and dynamic visual and auditory content and duration.

Input response data 208b can include, for example, input response start times, durations, densities, and types for inputs received by the computing device from the user within the context of the content provided to the user. For example, Input response times can be measured for input from various different input devices, such as, for example, a keyboard, a mouse, a trackball, and a touch screen and microphone. Input response times measured by PIA may include timing of the start of an input (e.g., in relation to changes in content), the length of the input (e.g., the length of a typed response), or the duration over which the input occurs (e.g., the time it takes for the user to complete an input). In some examples, the measured input response data is reduced into an input-action template representing the timing, duration, type, and density of human input back into the device. In some examples, the PIA can measure input response at regular intervals and associate the input-action templates with information density templates generated during the same interval, so as to provide proper correlation between the content presented to the user and the user's inputs in response to that content.

Information density templates 208a and input response data 208b can be correlated (e.g., comparing input response data to information density at the times that associated inputs were received) and analyzed 210 to determine the correspondence between the interaction data 208 and cognitive efficiency traits (e.g., Field Dependence-Independence, Impulsivity-Reflectivity, Range of Scanning, and Reading Rate). For example, the rate at which a user scrolls through text within a content window (e.g., input response data 208b) can be correlated to the user's reading rate. In some examples, however, a user's scroll rate may be dependent upon a vertical size of the content window (e.g., information density template 208a data). For instance, a smaller vertical window size would likely give rise to a higher scroll rate than a larger vertical window size. In addition, the size of the window can also be correlated to a user's range of scanning trait, for example, to a greater or lesser degree than to reading rate. For example, a user who often views text in a wide window may have a greater range of scanning than a user who often views text in a narrower window (at a different zoom setting). Similarly, for example, the speed with which a user responds to, for example, by selecting on or closing (e.g., input response data 208a), a pop up advertisement (e.g., information density template 208a data) can be correlated to the user's impulsivity-reflexivity trait.

The PIA can use the interaction data 208 to establish and/or refine scores 206 associated with each psychometric trait in a user's cognitive efficiency profile 204a. In some implementations, user interaction data 208 can be weighted 212 based on a measure of correspondence between the interaction data 208 and respective psychometric traits for generating or refining an associated psychometric trait score 206.

Aspects of Cognitive Efficiency Traits

When considering interaction features and measurable data in the user environment, there are a number of factors affecting command timing, for example, user sophistication in the environment, rendered visiospatial information complexity, visual efficiency, perceptual efficiency, cognitive efficiency, and other influences of cognitive strategy. The principle strategies from the previous initial listing include: Field Dependence-Independence, Impulsivity-Reflectivity, and Range of Scanning. Timing differences based on information context can be, for example, referred to as Cognitive Efficiency.

An example, analysis against features for a strong psychometric traits of efficiency are presented in Table 4.

TABLE 4
Ratings of classifier of Efficiency
against assumed Cognitive Strategies*

| Strategy | Measurability | Mutability | Composability |
|---|---|---|---|
| Field Dependence- | Indirectly | Immutable | Additive |
| Indep. | | | |
| Impulsivity- | Directly* | Experientially | Additive |
| Reflectivity | | | |
| Range of Scanning | Directly* | Consciously | Additive |
| Reading Rate | Directly* | Immutable | Additive |

*As previously noted, directly measurable here includes “Least Indirectly.”

In the example analysis, a cognitive efficiency classifier is strong in all four dimensions (e.g., all four traits). More than half of the traits are directly measurable, half are immutable, and the composition is additive. Reading rates may differ in a robust fashion within the human population, and reading rates and reading comprehension with respect to a given text classification are relatively stable once adulthood is reached. Further, reading rates are relatively invariant for an individual with respect to font size, font type, presentation contrast, and visual impairment in the population. In some examples, reading rate can be considered as an additive, immutable feature for overall cognitive efficiency, as the presence visual impairments or output variations may not correlate inversely with reading rates, but rather may correlates more confidently with effects of old age.

Referring to generation of a cognitive choice profile 204b, a PIA can generate a cognitive choice profile 204b for a user based on user/computer interaction data 218 including, for example, action profiles 218a, action counts data 218b, and content data 218c. In some examples, an action profile 218a is a profile of the number and type of potential interactions available to the user. For example, an action profile 218a can include a number of potential interactions (commands/decision that the user may input/choose) available to a user, and a classification of the types of interactions available to the user by both type and method of performing the interaction. For example, in a particular type of content (e.g., a user application such as a web browser or word processing application) it may be possible for a user to select menu item either by right clicking on the menu item with a mouse or by entering a key combination (e.g., “hot keys”). In some implementations, the PIA can receive reference information from one or more applications provided by the computing device. The reference information may include a complete or substantially complete classification of all of the interactions that the user is permitted to perform in the application.

Action count data 218b can include, for example, data related to the number of times that the user performs each of a plurality of different interactions permitted by the content (e.g., an application). For example, the action count data 218b can include a number of times that a user performs a specific action (e.g., selecting a menu item using a mouse click). If a user performs a specific action for the first time, the PIA may establish a new class of interaction and begin the count. For example, the first time the user selects a particular menu item using a hot key instead of a mouse click, the PIA can create a new interaction class for selecting item the particular menu item by using the hot key.

Content data 218c can include, for example, data related to the number and/or types of content (e.g., an applications) displayed to a user. In some examples, the content data 218c can be similar to the information density templates 208a described above.

Action profiles 218a, action counts data 218b, and content data 218c can be correlated (e.g., comparing input response data to information density at the times that associated inputs were received) and analyzed 220 to determine the correspondence between the interaction data 218 and cognitive choice traits (e.g., Adaptability-Innovation, Holist-Serialist, and Constricted-Flexible, and Impulsivity-Reflectivity). For example, a range of different operations (e.g., action count data 218b) that a user implements to perform a particular task can be correlated to the user's constricted-flexible psychometric trait. Furthermore, in some examples, correspondence strength of such action count data 218b to the user's constricted-flexible psychometric trait can depend on the number of different interactions available to the user for performing the particular task (e.g., action profile data 218a) and the user's use of such options across varying applications (e.g., content data 218c).

The PIA can use the interaction data 218 and to establish and/or refine scores 216 associated with each psychometric trait in a user's cognitive choice profile 204b. In some implementations, user interaction data 218 can be weighted 222 based on a measure of correspondence between the interaction data 218 and respective psychometric traits for generating or refining an associated psychometric trait score 216. For example, weightings 222 for one type of interaction data 218 can be generated based other types of interaction data 218. For instance, as described above, the correspondence strength of action count data 218b can depend on related action profile data 218a and content data 218c.

Aspects of Cognitive Choice Traits

When considering command choice in the user environment, there are, for example, two factors which can affect application state change, user choice, or interruption choice. For example, the user can launch a new application context, menu, submenu, keyed command, mouse command, gesture input, voice command, and close or switch application contexts as result of deliberation or cognition. A user or system action may, for example, give rise to an event of interruption, within which the user must render a choice to accept the interruption or continue. Cognitive choice traits can include, for example, Adaptability-Innovation, Holist-Serialist, and Constricted-Flexible, and, in some examples, Impulsivity-Reflectivity and Range of Scanning. Choice differences based on information context will be referred to as cognitive choice. In some examples, an additional trait that may be used in a choice classifier is Active Experimentation-Reflective Observation.

An example, analysis against features for a strong psychometric traits of choice are presented in
Table 5.

TABLE 5
Ratings of a classifier of Choice against
assumed Cognitive Strategies

| Strategy | Measurability | Mutability | Composability |
|---|---|---|---|
| Holist-Serialist | Indirectly | Situationally | Additive |
| Constricted-Flexible | Directly | Situationally | Additive |
| Adaptability- | Indirectly | Experientially | Additive |
| Innovation | | | |
| Range of Scanning | Directly | Situationally | Neutral |
| Impulsivity- | Indirectly | Consciously | Additive |
| Reflectivity | | | |

* Range of Scanning is noted with a composability of neutral, as it does not imply a command which will fundamentally alter application state with respect to the choice classifier.

Additionally, as both classifiers (e.g., cognitive efficiency and cognitive choice) share effects of Impulsivity-Reflectivity, they may not be completely orthogonal, and, in some implementations, such effects can be measured when considering fusion of the two classifier profiles into a single psychometric profile. For example, cognitive efficiency can contain timing anomalies related to Impulsivity-Reflectivity, and cognitive choice can contain choice biased towards errors and correction commands where Impulsivity yields higher error rates.

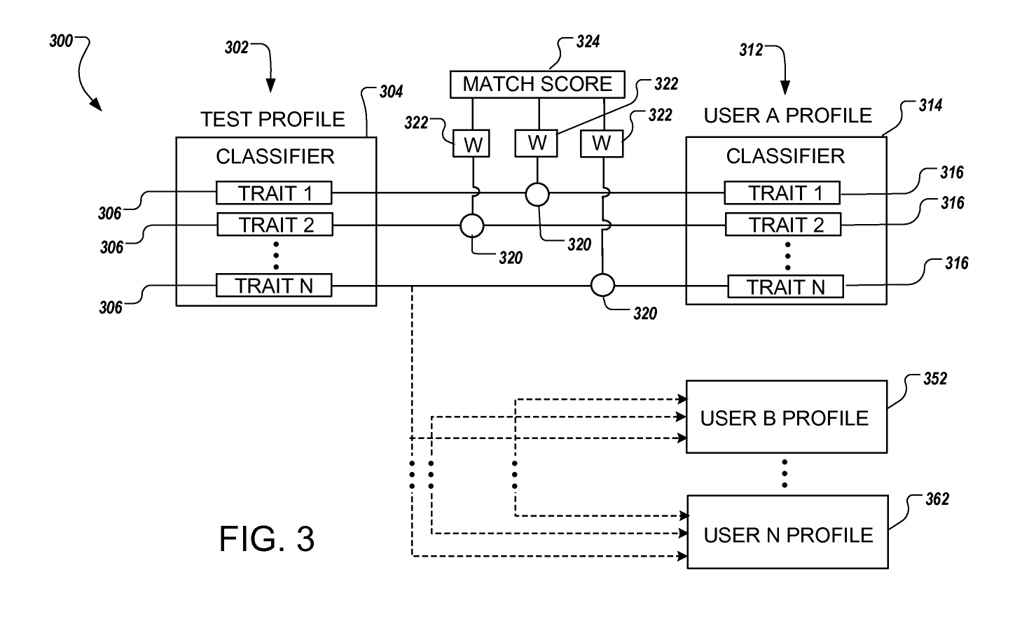

FIG. 3 depicts an example process 300 for performing identity verification using a psychometric profile in accordance with implementations of the present disclosure. The process 300 may be performed by a PIA operating on one or more computing suitable computing device such as a user computing device or server described above in reference to FIG. 1. As a user interacts with a computing device the PIA can monitor the content presented to the user and the user's interactions with the content to generate a test profile 302. The test profile 302 can, for example, be generated by a process such as process 200 described above. The test profile 302 can include one or more classifier profiles 304, (e.g., a cognitive efficiency profile and a cognitive choice profile), and each classifier profile 304 can include multiple psychometric traits scores 306.

The test profile 302 can be compared with one or more stored user profiles 312 to verify the user's identity. In some examples, user profiles 312 can be stored on a user computing device. In some examples, user profiles 312 can be stored on a remote computing device (e.g., server) and accessed by a user computing device to evaluate a test profile 302. The user profiles 312 can include the same or additional data than the test profile 302. For example, a user profile 312 can include can include one or more classifier profiles 314, (e.g., a cognitive efficiency profile and a cognitive choice profile), and each classifier profile 314 can include multiple psychometric traits scores 316

The PIA can verify a user's identity by comparing 320 psychometric trait scores 306 of the test profile 302 with related psychometric trait scores 316 (e.g., scores associated with the same type of psychometric trait) of the one or more user profiles 312. Comparison 320 results between related psychometric trait scores from the test profile 302 and the user profiles 312 can be used to determine a profile match score 324. The profile match score 324 can, for example, indicate the how closely related the test profile 302 is to particular user profile 312. The user's identity can be verified based on the profile match score 324, for example, by comparing the profile match score 324 to one or more verification threshold values. In some examples, a range of threshold values can indicate the strength of the match between the test profile 302 and the particular user profile 312.

In some implementations, the comparison 320 results between related psychometric trait scores from the test profile 302 and the user profiles 312 can be weighted 322 before being used to determine the profile match score 324. For example, the greatest vulnerability with respect to individual psychometric traits is the effect of meta-traits and their development over time as an adaptation technique. Meta-traits can include a set of strategies that are used to alter a given trait to a situation. For example, this effect can be included as a “mutability” dimension associated with one or more psychometric traits. For example, mutability may be the extent to which a trait can change, intentionally or unintentionally, for an individual user over time or based on differing contexts. In some examples, a mutability dimension associated with one or more psychometric traits can be incorporated into the PIA user verification process as weightings 322.

The following ranges of example mutability weightings are listed from weakest to strongest in terms of the ability to impersonate or falsify an identity.

### Example Ranges:

[4] Consciously: A typical individual may omnidirectionally, bidirectionally, or one-time alter an associated psychometric trait based on some learned or observed behavior, decision style, or other active control, random frequency.
[3] Unconsciously: A typical individual may omnidirectionally, bidirectionally, or one-time alter an associated psychometric trait based on a stressor response, environmental response, learned or observed behavior, or neurological disorder, random frequency.
[2] Situationally: A typical individual may bidirectionally alter the an associated psychometric trait based on situational pressures caused by environmental change, with predictable frequency.
[1] Experientially: A typical individual may omnidirectionally alter the an associated psychometric trait in a translational way, moving from one to another over time, gradually, with low frequency.
[0] Immutable: A typical individual cannot alter the an associated psychometric trait, it is fundamental to an individual's perceptual strategies, cognitive performance, or other developmental, physiological, or characteristic traits.

Table 6 represents an example set of relationships between various psychometric traits and mutability.

TABLE 6
Cognitive Strategies

| Classifier | Strategy | Mutability | Weight |
|---|---|---|---|
| Choice | Holist-Serialist | Situationally | 2 |
| Choice | Constricted-Flexible | Situationally | 2 |
| Choice | Adaptability-Innovation | Experientially | 1 |
| Choice | Impulsivity-Reflectivity** | Consciously | 4 |
| Efficiency | Field Dependence-Independence | Immutable | 0 |
| Efficiency | Impulsivity-Reflectivity** | Experientially | 1 |
| Efficiency | Range of Scanning | Consciously | 4 |
| Efficiency | Reading Rate* | Immutable | 0 |

In some examples, psychometric traits can be weighted within each classifier and between classifiers in terms of less mutable component features, to improve overall reliability of the method, and reduce attack vector viability.

In some examples, a PIA can perform user identification, for example, by comparing a test profile 302 to multiple stored user profiles (e.g., user profile 312, 352, and 362) and determining which of the multiple user profiles best matches the test profile 302. The PIA can, for example, use respective profile match scores 324 to determine which of the multiple user profiles best matches the test profile 302. In some implementations, a test profile can be considered a “match” for one of the user profiles out of the multiple user profiles only if a respective profile match score 324 exceeds a match threshold.

In some examples, a test profile 302 is a temporary psychometric profile of a user generated authenticate or identify the user. In some implementations, the test profile 302 may reflect data obtained from interactions between the user an computing device during a limited amount of time such as, for example, a user/computing device session (e.g., a period of time form which a user logs into a computing device and subsequently logs out of the computing device), a temporal period (e.g., a few minutes, hours, or a day).

In some implementations, authenticating the user can include verifying a purported identity of the user identify, for example, by comparing the a test profile 302 of the user to a stored psychometric profile 312 of the user. A particular stored psychometric profile may be selected based on the user's login identity (e.g., purported identity). In some implementations, Identifying the user can include comparing a test profile of the user 302 to multiple stored psychometric profiles to determine a “best match” between the test profile 302 and one of the stored profiles (312, 352, 362).

Some implementations can enter an exception mode when a match score 324 is close to a verification threshold (e.g., within an error threshold). In the exception mode, the PIA can re verify the individuals identity and incorporate data from the test profile 302 into the verified user's stored psychometric profile 312 to update the user's stored profile 312 and accommodate for behavior adaptation over time.

FIG. 4 depicts an example process 400 for generating a cognitive efficiency profile of a user in accordance with implementations of the present disclosure. The process 400 may be performed by a PIA operating on one or more computing suitable computing device such as a user computing device or server described above in reference to FIG. 1.

The PIA monitors content provided by the computing device to a user (410). The content may include the number of application windows open, window dimensions, paint time, application association, auditory input, and estimated information density. The PIA obtains information density templates based on the presented content (420). Information density is a measure of the amount of information presented to a user per unit time and the context in which the information is presented. An example of low information density content is a screen displaying a plain background with a simple image and 1-2 sentences separate from the image. By contrast, an example of high information density content is a screen with multiple windows open for multiple applications, some windows having animated advertisements, and receiving active input from a user (e.g., typing). This information is reduced to an information density template from the perspective of information presented to the user, including static and dynamic visual and auditory content and duration. (TODO: REPEAT SECTION ABOVE, REMOVE?)

The PIA obtains input response data related to input received by the computing device from the user (430). For example, the PIA can measure input response start times, durations, densities, and types for inputs received by the computing device from the user, and within the context of the content provided to the user. Input response times may be measured for input from various different input devices, such as, a keyboard, a mouse, a trackball, and a touch screen and microphone. Input response times measured by PIA may include timing of the start of an input (e.g., in relation to changes in content), the length of the input (e.g., the length of a typed response), or the duration over which the input occurs (e.g., the time it takes for the user to complete an input). This data is reduced into an input-action template representing the timing, duration, type, and density of human input back into the device.

In addition, the PIA may measure input response at regular intervals and associate the input-action templates with information density templates generated during the same interval, so as to provide proper correlation between the content presented to the user and the user's inputs in response to that content.

The PIA determines scores for one or more psychometric traits based on the input response data and the information density templates (440). For example, the psychometric trait scores can form a cognitive efficiency profile of the user based on the monitored information density templates and the measured input-action templates. The PIA analyzes the monitored content and the measured input response times, and scores the user's cognitive efficiency in one or more cognitive strategies (e.g., Field Dependence-Independence, Impulsivity-Reflectivity, Range of Scanning, and Reading Rate). In addition, the PIA will test the test the relationship between data received during different intervals to further refine the user's cognitive efficiency profile. The PIA may generate the user's cognitive efficiency profile using machine learning techniques (e.g., Simple Bayes, Neural Network, and/or SVM with RBF kernel).

The PIA stores the psychometric trait scores as part of a user's psychometric profile (450). The scores can be stored in a user psychometric profile on a user computing device (e.g., a mobile device), or on a remote computing system (e.g., a server). In some implementations, the psychometric trait scores can be used to refine existing psychometric trait scores for the user, for example, to refine the user's existing psychometric profile.

In some implementations, the PIA may measure environmental conditions of the environment in which the user is interacting with the computing device. The environmental conditions may be used, for instance, the user interaction data (e.g., the input response times). For instance, the computing device may have a microphone to measure background noise. User interaction data captured while a user is distracted by a background noise may be less representative of the user's cognitive efficiency, for example, and therefore, be weighted lower than user interaction data captured during a period of minimal background noise.

In some implementations, the PIA may perform process 400 as part of a learning mode. During the learning mode, the PIA is using process 400 to learn the user's cognitive efficiency traits. The PIA may periodically test the user's cognitive efficiency profile to determine whether the user's cognitive efficiency traits have been sufficiently classified to be used for psychometric identification or verification of the user. For example, PIA may perform a statistical analysis of the profile and determine whether the user's profile meets a threshold level of uniqueness.

Once the user's cognitive efficiency profile has been sufficiently classified (e.g., a confidence value associated the user's cognitive efficiency profile is within a threshold value), the PIA may transition to an identification/verification and continuous learning mode. In the identification/verification and continuous learning mode the PIA performs identification and verification processes using the user's cognitive efficiency profile, while at the same time continuing to perform process 400 to further refine the user's cognitive efficiency profile.

FIG. 5 depicts an example process 500 for generating a cognitive choice profile of a user in accordance with implementations of the present disclosure. The process 500 may be performed by a PIA operating on one or more computing suitable computing device such as a user computing device or server described above in reference to FIG. 1.

The PIA monitors a user's interactions with content provided to the user by a computing device (510). The content provided by the computing device permits the user to perform a plurality of different interactions. For example, the content may include an application that permits the user to provide a voice command, select options in a menu with a mouse, selection options in the menu using a key combination (e.g., hot keys). In addition, the PIA may construct a profile of the number of potential interactions (commands/decision that the user may input/choose) available to a user, and may classify the types of interactions available to the user by both type and method of performing the interaction. For example, it may be possible to select menu item A of a word processing application either by right clicking on the menu item with a mouse or by entering a hot key combination. In some implementations, the PIA may receive reference information from one or more applications provided by the computing device. The reference information may include a complete or substantially complete classification of all of the interactions that the user is permitted to perform in the application.

The PIA obtains action count data based on monitoring the user's interactions with the content provided by the computing device (520). For example, the PIA can record data related to the number of times that the user performs each of a plurality of different interactions permitted by the content. The action count data can include a number of times that the user performs each of the plurality of different types of interactions. For example, the PIA may count the number of times that a user performs a specific action (e.g., selecting a menu item using a mouse click). If a user performs a specific action for the first time, the PIA may establish a new class of interaction and begin the count. For example, the first time the user selects menu item A using a hot key instead of a mouse click, the PIA may create a new interaction class for selecting item A via hot keys.

The PIA determines scores for one or more psychometric traits based on the plurality of different types of interactions permitted by the content and the action count data (530). For example, the psychometric trait scores can form a cognitive choice profile of the user based on the plurality of different types of interactions permitted by the content and the recorded data related to a number of times that the user performs each different type of interaction. The PIA analyzes the plurality of different types of interactions permitted by the content and the recorded data related to a number of times that the user performs each different type of interaction and scores the user's cognitive choice in one or more cognitive strategies (e.g., Holist-Serialist, Constricted-Flexible, Adaptability-Innovation, Impulsivity-Reflectivity). In addition, the PIA will test the test the relationship between data received during different intervals to further refine the user's cognitive efficiency profile. The PIA may generate the user's cognitive choice profile using machine learning techniques (e.g., Simple Bayes, Neural Network, and/or SVM with RBF kernel).

The PIA stores the psychometric trait scores as part of a user's psychometric profile (540). The scores can be stored in a user psychometric profile on a user computing device (e.g., a mobile device), or on a remote computing system (e.g., a server). In some implementations, the psychometric trait scores can be used to refine existing psychometric trait scores for the user, for example, to refine the user's existing psychometric profile.

In some implementations, the PIA may perform process 500 as part of a learning mode. During the learning mode, the PIA is using process 500 to learn the user's cognitive choice traits. The PIA may periodically test the user's cognitive choice profile to determine whether the user's cognitive choice traits have been sufficiently classified to be used for psychometric identification or verification of the user. For example, PIA may perform a statistical analysis of the profile and determine whether the user's profile meets a threshold level of uniqueness.

Once the user's cognitive choice profile has been sufficiently classified (e.g., a confidence value associated the user's cognitive choice profile is within a threshold value), the PIA may transition to an identification/verification and continuous learning mode. In the identification/verification and continuous learning mode the PIA performs identification and verification processes using the user's cognitive choice profile, while at the same time continuing to perform process 500 to further refine the user's cognitive choice profile.

In some implementations, the PIA may perform both processes 400 and 500 to develop a cognitive efficiency profile and a cognitive choice profile for a user. The PIA may then utilize both profiles when performing user authentication, for example, the PIA may implement one or more classifier fusion techniques (e.g., decision level fusion or matching level fusion) to improve user authentication accuracy.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, although various techniques generally are disclosed herein as being performed externally to an electronic social networking platform, in some implementations, the techniques disclosed herein may be performed internally by an electronic social networking platform.

Furthermore, it should be noted that for situations in which the systems discussed herein collect personal information about users, the users may be provided with an opportunity to opt in/out of programs or features that may collect personal information. In addition, certain data may be anonymized in one or more ways before it is stored or used, so that personally identifiable information is removed.

For example, the approaches described do not capture any user input that could absolutely identify an individual using a device without association to the principle authentication credentials. No information derived from GUI information density estimation absolutely resolves to information on the screen and screen information cannot be reverse engineered by capture of the information density estimators under consideration. Further, keyed command sequences are limited to those which follow operating system keyed command sequences for GUI applications, which are strongly differentiated from general keyboard input which could contain personally identifiable information (PII). Absolute inputs are not required, rather only information density, timing, during, action density, and other non-personally identifying pieces of information.

What is claimed is:

1. A computer implemented method executed by one or more processors, the method comprising:
monitoring, by the one or more processors, content presented by a computing device to a user;
obtaining, by the one or more processors, information density templates based on the presented content;
obtaining, by the one or more processors, input response data related to inputs received by the computing device from the user;
determining, by the one or more processors, scores for one or more psychometric traits based on the input response data and the information density templates; and
storing the scores for the one or more psychometric traits in a psychometric profile of the user.

2. The computer implemented method of claim 1, wherein obtaining the input response data comprises measuring a length of responses for inputs received by the computing device from the user.

3. The computer implemented method of claim 1, wherein obtaining the input response data comprises measuring a length of time between inputs received by the computing device from the user.

4. The computer implemented method of claim 1, wherein obtaining the information density templates based on the presented content comprises converting the content presented to the user into information density templates at regular intervals, and
wherein obtaining the input response data comprises measuring input response times for inputs received by the computing device from the user during the regular intervals.

5. The computer implemented method of claim 1, wherein obtaining the input response data comprises:
converting the user inputs into input templates at event based intervals; and
measuring input response times for keyboard inputs, mouse inputs, trackball inputs, and touch screen inputs.

6. The computer implemented method of claim 1, wherein monitoring content presented by a computing device to a user comprises monitoring any of visiospatial information, window dimensions, paint time, application association, audio information, event and interruption information, dynamic content measurement per unit time, or information density of each of those aspects.

7. The computer implemented method of claim 1, wherein determining scores for one or more psychometric traits based on the input response data and the information density templates comprises generating scores for the one or more psychometric traits using a machine learning model.

8. The computer implemented method of claim 1, wherein the one or more psychometric traits are cognitive efficiency traits.

9. A computer implemented method executed by one or more processors, the method comprising:
monitoring, by the one or more processors, a user's interactions with content provided to the user by a computing device, the content permitting the user to perform a plurality of different types of interactions;
obtaining, by the one or more processors and based on monitoring the user's interactions with the provided content, action count data including a number of times that the user performs each of the plurality of different types of interactions;
determining, by the one or more processors, scores for one or more psychometric traits based on the plurality of different types of interactions permitted by the content and the action count data; and
storing the scores for the one or more psychometric traits in a psychometric profile of the user.

10. The computer implemented method of claim 9, further comprising obtaining action profile data including data identifying multiple interactions available to a user to perform an operation with the content, and
wherein determining scores for one or more psychometric traits comprises determining scores for one or more psychometric traits based on the plurality of different types of interactions permitted by the content, the action count data, and the action profile data.

11. The computer implemented method of claim 10, further comprising correlating the action count data and the action profile data, and
wherein determining scores for one or more psychometric traits comprises determining scores for one or more psychometric traits based on the correlated action count data and action profile data.

12. The computer implemented method of claim 9, wherein monitoring content presented by a computing device to a user comprises monitoring a number and type of content provided to a user.

13. The computer implemented method of claim 9, wherein determining scores for one or more psychometric traits based on the plurality of different types of interactions permitted by the content, the action count data comprises generating scores for the one or more psychometric traits using a machine learning model.

14. The computer implemented method of claim 9, wherein the one or more psychometric traits are cognitive choice traits.

15. A computer implemented method executed by one or more processors, the method comprising:
monitoring, by the one or more processors, content presented by a computing device to a user;
obtaining, by the one or more processors, information density templates based on the presented content;
obtaining, by the one or more processors, input response data related inputs received by the computing device from the user;
obtaining, by the one or more processors, action profile data including data identifying a plurality of interactions available to a user to perform an operation with the content
determining, by the one or more processors and based on monitoring the user's interactions with the provided content, action count data including a number of times that the user performs each of the plurality of different types of interactions
determining, by the one or more processors, scores for a first set of one or more psychometric traits based on the input response data and the information density templates;
determining, by the one or more processors, scores for a second set of one or more psychometric traits based on the plurality of different types of interactions permitted by the content and the action count data; and
storing the scores for the first set of one or more psychometric traits and the second set of one or more psychometric traits in a psychometric profile of the user.

16. The computer implemented method of claim 15, wherein obtaining the input response data comprises measuring a length of responses for inputs received by the computing device from the user.

17. The computer implemented method of claim 15 wherein obtaining the input response data comprises measuring a length of time between inputs received by the computing device from the user.

18. The computer implemented method of claim 15, wherein obtaining the information density templates based on the presented content comprises converting the content presented to the user into information density templates at regular intervals, and
wherein obtaining the input response data comprises measuring input response times for inputs received by the computing device from the user during the regular intervals.

19. The computer implemented method of claim 15, further comprising obtaining action profile data including data identifying multiple interactions available to a user to perform an operation with the content, and
wherein determining scores for the second set of one or more psychometric traits comprises determining scores for the second set of one or more psychometric traits based on the plurality of different types of interactions permitted by the content, the action count data, and the action profile data.

20. The computer implemented method of claim 1, wherein the first set of one or more psychometric traits are cognitive efficiency traits, and
wherein the second set of one or more psychometric traits are cognitive choice traits.
